(19) United States
(12) Patent Application Publication
(10) Pub. No.: US 2014/0372457 A1
(43) Pub. Date: Dec. 18, 2014

(54) METHOD AND DEVICE FOR PROCESSING DATA

(71) Applicant: Tencent Technology (Shenzhen) Company Limited, Shenzhen (CN)

(72) Inventors: Yi Yang, Shenzhen (CN); Yongqiang Zou, Shenzhen (CN); Ke Lu, Shenzhen (CN); Zheng Chen, Shenzhen (CN); Haijun Wu, Shenzhen (CN); Tao Yu, Shenzhen (CN); Luxin Li, Shenzhen (CN); Jiaxu Wu, Shenzhen (CN); Jingbing Cui, Shenzhen (CN); Diaoqin Xin, Shenzhen (CN); Zan Zou, Shenzhen (CN)

(73) Assignee: Tencent Technology Shenzhen Company Limited

(21) Appl. No.: 14/294,989

(22) Filed: Jun. 3, 2014

Related U.S. Application Data
(63) Continuation of application No. PCT/CN2013/090441, filed on Dec. 25, 2013.

(30) Foreign Application Priority Data
Jun. 17, 2013 (CN) 201310239700.1

(51) Int. Cl. G06F 7/24

(52) U.S. Cl. CPC G06F 7/24
USPC 707/752

(57) ABSTRACT

A method and device for processing data in the field of data process are disclosed. The method includes: sorting samples according to primary keys, wherein the primary key includes a feature serial number and a sample serial number, and wherein a column value corresponding to the primary key is used as a feature value for the sample; acquiring a statistic of each feature in each category by taking the primary key and the feature value as an input key-value pair and calculating with a first algorithm model, and outputting the feature serial number and the statistic as an output key-value pair; and acquiring a contribution value of each feature to the category by performing calculation on the output key-value pair with a second algorithm model, and selecting a feature based on the contribution value. The device includes a sorting module, a first processing module and a second processing module.

### CROSS-REFERENCE TO RELATED APPLICATIONS

This application is a continuation application of International Application No. PCT/CN2013/090441, titled “Method and device for processing data”, filed on Dec. 25, 2013, which claims priority to Chinese patent application No. 201310239700.1 titled “Method and device for processing data” and filed with the State Intellectual Property Office on Jun. 17, 2013, which is incorporated herein by reference in its entirety.

### FIELD OF THE INVENTION

The present invention generally relates to the field of data processing, and in particular to a method and device for processing data.

### BACKGROUND OF THE INVENTION

With the development of the internet, the amount of data needed to be processed is rapidly increased due to information explosion. The feature dimensions corresponding to the data are also increased and may reach to the order of hundreds of millions. There will be a high cost if direct processing is performed. Therefore, there is a need to effectively process the data of high dimensions.

### SUMMARY OF THE INVENTION

In order to improve the data processing rate, embodiments of the present invention provide a method and device for processing data. The technical solutions of the invention are as follows:

According to an aspect of the present invention, there is provided a method for processing data, including:

sorting samples from the data according to primary keys, wherein the primary key includes a feature serial number and a sample serial number, and wherein a column value corresponding to the primary key is a feature value for the sample;

acquiring a statistic of each feature in each category by taking the primary key and the feature value as an input key-value pair and calculating with a first algorithm model, and outputting the feature serial number and the statistic as an output key-value pair; and

acquiring a contribution value of each feature to the category by performing calculation on the output key-value pair with a second algorithm model, and selecting a feature based on the contribution value.

According to another aspect of the present invention, there is provided a device for processing data, including:

a sorting module, configured to sort samples from the data according to primary keys, wherein the primary key includes a feature serial number and a sample serial number, and wherein a column value corresponding to the primary key is a feature value for the sample;

a first processing module, configured to acquire a statistic of each feature in each category by taking the primary key and the feature value as an input key-value pair and calculating with a first algorithm model, and outputting the feature serial number and the statistic to as an output key-value pair; and

a second processing module, configured to acquire a contribution value of each feature to the category by performing calculation on the output key-value pair with a second algorithm model, and select a feature based on the contribution value.

The advantageous effects achieved by the present invention are as follows. The samples are sorted according to primary keys. A statistic of each feature in each category is acquired by taking the primary key and a corresponding feature value as an input key-value pair and calculating with a first algorithm model, and the feature serial number and the statistic are output as an output key-value pair. A contribution value of each feature to the category is acquired by performing calculation on the output key-value pair with a second algorithm model, and a feature is selected based on the contribution value. Therefore, the present invention can greatly improve data processing rate, reduce data processing time and consequently computing costs. Moreover, the fast feature selection is achieved by performing two algorithm model calculations.

### BRIEF DESCRIPTION OF THE DRAWINGS

The accompanying drawings used in the description of the embodiments are described briefly as follows, so that the technical solutions according to the embodiments of the present invention become much clearer. The accompanying drawings in the following description represent only some embodiments of the present invention. For those skilled in the art, other embodiments may be discerned from these drawings without any creative work.

FIG. 1 is a flowchart that shows a method for processing data according to a first embodiment of the present invention;

FIG. 2 is a flowchart that shows a method for processing data according to a second embodiment of the present invention;

FIG. 3 is a schematic diagram that shows a process of the MapReduce model according to the second embodiment of the present invention;

FIG. 4 is a schematic structural diagram of a device for processing data according to a third embodiment of the present invention;

FIG. 5 is a second schematic structural diagram of a device for processing data according to the third embodiment of the present invention; and

FIG. 6 is a third schematic structural diagram of a device for processing data according to the third embodiment of the present invention.

### DETAILED DESCRIPTION OF THE INVENTION

In order that the purpose, technical solution and advantages of the present invention can be more apparent, embodiments of the present invention are further described in detail in conjunction with the accompanying drawings as follows.

### First Embodiment

Referring to FIG. 1, the embodiment provides a method for processing data, including:

101: sorting samples according to primary keys, wherein the primary key includes a feature serial number and a sample serial number, and wherein a column value corresponding to the primary key is a feature value for the sample;

102: acquiring a statistic of each feature in each category by taking the primary key and the feature value as an input key-value pair and calculating with a first algorithm model, and outputting the feature serial number and the statistic as an output key-value pair; and

103: acquiring a contribution value of each feature to the category by performing calculation on the output key-value pair with a second algorithm model, and selecting a feature based on the contribution value.

In the embodiment, the primary key refers to a column or a combination of columns in a distributed database storing the samples. A value in the column or the combination of columns may uniquely identify a row in the table of the database. The primary key and the corresponding column value may also constitute a key-value pair.

According to the embodiment, the samples may be stored in the database in advance. The samples may be stored according to the categories, and each category includes one or more samples. A feature refers to an element relevant to a sample and may reflect the attributes/property of the sample to some extent. The feature can be set as needed. Each feature has a feature serial number for identifying the feature. Each feature further has a feature value. The specific value of the feature value may be obtained by performing statistics or calculating based on a preset rule.

In the embodiment, specifically, the first algorithm model or the second algorithm model may be the MapReduce model. Certainly, other algorithm model may be used in other embodiment, and the embodiment is not specifically limited thereto.

In the embodiment, the contribution value shows representativeness of a feature for a certain category. The larger the contribution value, the stronger the representativeness of the feature for the category. The less the contribution value, the weaker the representativeness of the feature for the category. Therefore, the contribution value may reflect whether the corresponding feature may represent a category so that the feature may be selected based on the contribution value.

In combination with the method mentioned above, in a first embodiment, the sorting samples according to primary keys includes:

sorting the samples according to the feature serial numbers, and then sorting the samples with the same feature serial number according to the sample serial numbers, in the case where the primary key is sequentially spliced by the feature serial number and the sample serial number; or

sorting the samples according to the sample serial numbers, and then sorting the samples with the same sample serial number according to the feature serial numbers, in the case where the primary key is sequentially spliced by the sample serial number and the feature serial number.

In combination with the method mentioned above, in a second embodiment, the step of acquiring a statistic of each feature in each category by calculating with a first algorithm model includes a step of performing statistics on the feature values of the samples in each category and/or performing statistics on the number of occurrence for the features of the samples in each category by using the first algorithm model.

In combination with the second embodiment mentioned above, in a third embodiment, the step of performing statistics on the feature values for the samples in each category includes: for each category, calculating a sum of the feature values for all the samples belonging to the category; and/or, for each category, calculating a sum of square of the feature values for all the samples in the same category.

In combination with the second embodiment mentioned above, in a fourth embodiment, the step of performing statistics on the number of occurrence for the features of the samples in each category includes: for each category, recording, for each feature, the number of times that a feature value thereof being a non-zero value in all the samples in the category, as the number of occurrence for the feature in the samples in the category.

In combination with the method mentioned above, in a fifth embodiment, the step of acquiring a contribution value of each feature to the category by performing calculation on the output key-value pair with a second algorithm model includes: performing statistics on the feature values for the samples in all the categories and/or performing statistics on the numbers of occurrence of the features in the samples in all the categories by using the second algorithm model, and calculating the contribution value of each feature to the category according to the result of the statistics.

In combination with the method mentioned above, in a sixth embodiment, the step of selecting a feature based on the contribution value includes determining a specified number of the contribution values in a descending order of the contribution values, and selecting the features corresponding to the determined contribution values from all the features.

In the above-mentioned method according to the invention, the samples are sorted according to primary keys; a statistic of each feature in each category is acquired by taking the primary key and a corresponding feature value as an input key-value pair and calculating with a first algorithm model, and the feature serial number and the statistic are output as an output key-value pair; a contribution value of each feature to the category is acquired by performing calculation on the output key-value pair with a second algorithm model, and a feature is selected based on the contribution value. Therefore, the present invention can greatly improve data processing rate, shorten data processing time and reduce computing cost. Moreover, the fast feature selection is achieved by performing two algorithm model calculations.

### Second Embodiment

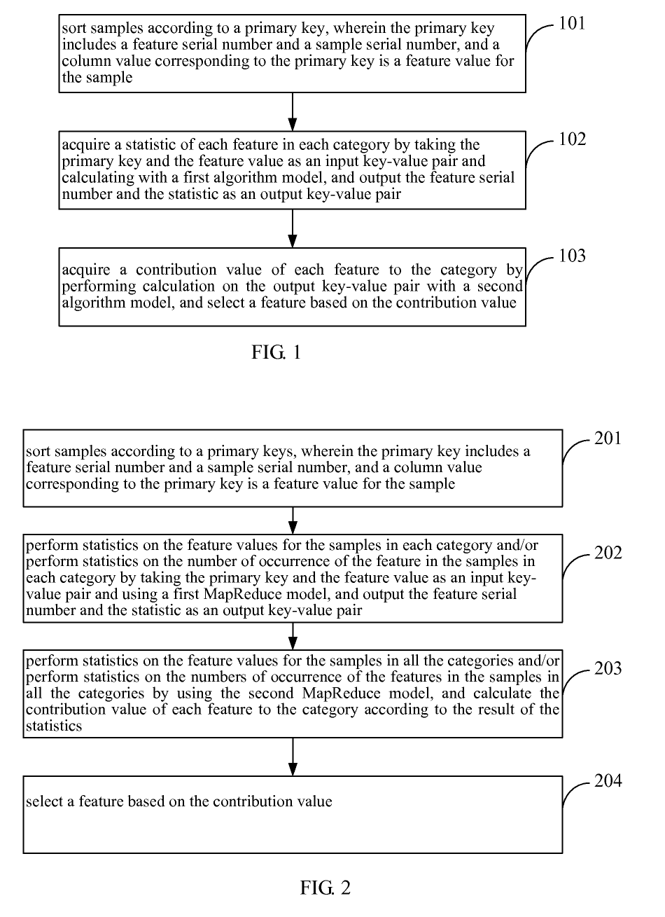

Referring to FIG. 2, the embodiment provides a method for processing data including the follows steps.

201: sorting samples according to primary keys, wherein the primary key includes a feature serial number and a sample serial number, and a column value corresponding to the primary key is a feature value for the sample.

In the embodiment, the primary key refers to a column or a combination of columns in a distributed database storing the samples. A value in the column or the combination of columns may uniquely identify a row in the table of the database. The primary key and the corresponding column value may constitute a key-value pair. The primary key in this embodiment is the combination of columns and includes a feature serial number and a sample serial number. The column value corresponding to the primary key is the feature value for the sample. In the primary key, there are two ways to sequentially splice the feature serial number and the sample serial number. One way is that the feature serial number and the sample serial number are sequentially spliced, and the other way is that the sample serial number and the feature serial number are sequentially spliced. The embodiment is not specifically limited thereto.

According to the embodiment, the samples may be stored in the database in advance. The samples may be stored according to the categories, and there are one or more samples in each category. A feature refers to an element relevant to the sample and may reflect the attributes/property of the sample to some extent. The feature can be set as needed. Each feature has a feature serial number for identifying the feature. Each feature also has a feature value. The specific value of the feature value may be obtained by performing statistics or calculating following a preset rule.

For example, the samples are two books in the categories of math and sports, respectively. The features may include formula and basketball. The feature value of “basketball” is the number of occurrence of this word in a sample, and the feature values of “basketball” for the two books are 8 and 0 respectively. The feature value of “formula” is the number of occurrence of this word in a sample, and the feature values of “formula” for the two books are 0 and 5 respectively.

In this step, in one embodiment, the sorting samples according to primary keys may include:

sorting the samples according to the feature serial numbers, and then sorting the samples with the same feature serial number according to the sample serial numbers, in the case where the primary key is sequentially spliced by the feature serial number and the sample serial number. For example, there are three samples, of which the sample serial numbers are 1, 2 and 3 respectively. Moreover, there are three features, of which the feature serial numbers are 1, 2 and 3 respectively. The result of the sorting shown in Table 1 can be obtained in the way to sort the samples based on the feature serial numbers and then based on the sample serial numbers.

TABLE 1

feature serial number 1 + sample serial number 1
feature serial number 1 + sample serial number 2
feature serial number 1 + sample serial number 3
feature serial number 2 + sample serial number 1
feature serial number 2 + sample serial number 2
feature serial number 2 + sample serial number 3
feature serial number 3 + sample serial number 1
feature serial number 3 + sample serial number 2
feature serial number 3 + sample serial number 3

In this step, in another embodiment, the sorting samples according to primary keys includes:

sorting the samples according to the sample serial numbers, and then sorting the samples with the same sample serial number according to the feature serial numbers, in the case where the primary key is sequentially spliced by the sample serial number and the feature serial number. For example, there are three samples, of which the sample serial numbers are 1, 2 and 3 respectively. Moreover, there are three features, of which the feature serial numbers are 1, 2 and 3 respectively. The result of the sorting shown in Table 2 can be obtained in the way to sort the samples based on the sample serial numbers and then based on the feature serial numbers.

TABLE 2

sample serial number 1 + feature serial number 1
sample serial number 1 + feature serial number 2
sample serial number 1 + feature serial number 3
sample serial number 2 + feature serial number 1
sample serial number 2 + feature serial number 2
sample serial number 2 + feature serial number 3
sample serial number 3 + feature serial number 1
sample serial number 3 + feature serial number 2
sample serial number 3 + feature serial number 3

202: performing statistics on the feature values for the samples in each category and/or performing statistics on the number of occurrence of the features in the samples in each category by using a first MapReduce model and taking the primary key and the feature value as an input key-value pair, and outputting the feature serial number and the statistics as an output key-value pair.

The embodiment is illustrated by taking the MapReduce model as an algorithm model. Certainly, other algorithm model may also be used to implement the embodiment, which is not described herein.

In the embodiment, the first MapReduce model may process data by using the Map mapping function and the Reduce simply function. The Map mapping function is used to calculate the feature value corresponding to the primary key to obtain an intermediate value which includes but not limited to: the feature value itself, the squared value of the feature value, the count value of whether the feature value is zero and so on. As for the count value, the count value is zero if the feature value is zero; and the count value is 1 if the feature value is not zero, and the embodiment is not specifically limited thereto. The intermediate values with the same feature serial number which are output by the Map function are induced as an intermediate value collection which is output to the Reduce function by using the MapReduce frame. The Reduce function performs statistics on the intermediate values in the intermediate value collection, to obtain for example a sum of the feature values, a sum of the squared values of the feature values, a sum of the count values and so on, and to obtain a statistic for each feature. The feature serial number and the statistic are output as an output key-value pair. Furthermore, the output key-value pair can be stored in the database mentioned above by using the Reduce function. Specifically, the feature serial number in the output key-value pair is taken as the key and the statistic is taken as the value corresponding to the key. There may be more than one Map functions in the first MapReduce model. Moreover, there may also be multiple Reduce functions. The key-value pairs processed by each Reduce function share the same key.

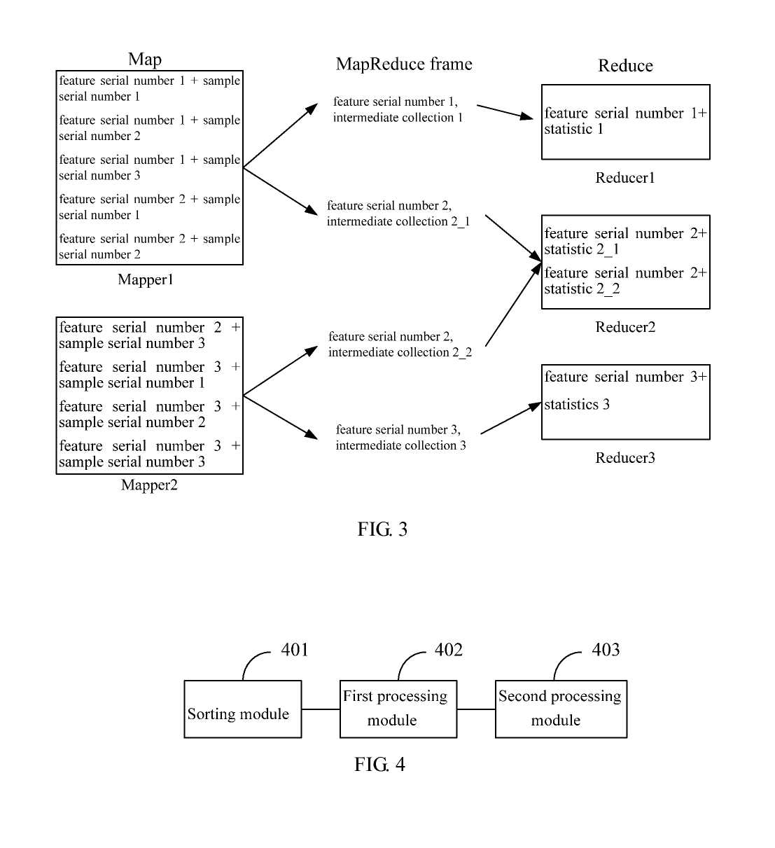

For example, reference is made to FIG. 3 which is a schematic diagram that shows a process with the first MapReduce model. As shown in FIG. 3, nine records for 3 samples are output into two Map functions. The primary key which is sequentially spliced by the feature serial number and the sample serial number is taken as the input key. The primary keys are sorted before being input into the Map function, as shown in the figure. After the square of each feature value and whether the count value of the feature value is zero are obtained by using the Map function, the obtained intermediate values are induced into intermediate collections by the MapReduce frame according to the feature serial numbers. The key-value pairs output by the Mapper1 function are induced into “feature serial number 1” and corresponding “intermediate collection 1”, as well as “feature serial number 2” and the corresponding “intermediate collection 2_{—}1”; the key-value pairs output by using the Mapper2 function are induced into “feature serial number 2” and the corresponding “intermediate collection 2_{—}2”, as well as “feature serial number 3” and the corresponding “intermediate collection 3”. The “feature serial number 1” and the corresponding “intermediate collection 1” are input into the Reducer 1 function for calculation of the statistic. For example, the feature values for all the samples in the intermediate collection 1 are accumulated, or the square of feature values for all the samples in the intermediate collection 1 are accumulated, or the count values for all the samples in the intermediate collection are accumulated. In this way, the statistic 1 may be obtained. The feature serial number 1 and the corresponding statistic 1 may be output as an output key-value pair. Similar, Reducer 2 function and Reducer 3 function can also perform calculation of the statistic and output the feature serial number and the corresponding statistic as an output key-value pair.

As can been seen from the example described above, apparently, the primary keys which are taken as the input of the Map function are the sorted primary keys. Therefore, the amount of intermediate data in an induction process may be reduced, the number of times for induction may also be reduced and the date processing rate may be improved, during a merging process performed on the output of the Map function by the MapReduce frame.

In Step 202, the performing statistics on the feature values for the samples in each category may include:

for each category j, calculating a sum, sum_{f}^{j}, of the feature values for all the samples belonging to the category j; and/or

for each category j, calculating a sum of square, sum_q_{f}^{j}, of the feature values for all the samples belonging to the category j.

For example, in the case where there are M samples and the feature dimension is N, specifically, the M samples belong to W categories, j=1,2, . . . , W, the feature value of the f^{th} feature for the sample i belonging to the j^{th} category is xᵢ_{_{f}}^{j}, f=1,2, . . . , N. Specifically, one sample can only belong to one category and cannot belong to multiple categories at the same time. One category may include multiple samples. The sum_{f}^{j} can be calculated by using the following formula:

$${sum}_{f}^{j} = {\sum }_{i = 1}^{M} {x}_{{i}_{f}}^{j} ; \qquad ( 1 )$$

The sum_q_{f}^{j} may be calculated by using the following formula:

$${sum\_q}_{f}^{j} = {\sum }_{i = 1}^{M} {( {x}_{{i}_{f}}^{j} )}^{2} ; \qquad ( 2 )$$

In Step 202, the performing statistics on the number of occurrence for the feature of the samples in each category may include:

for each category j, recording for each feature f, the number of times that a feature value thereof being a non-zero value in all the samples in the category j, as the number of occurrence of the feature in the samples in the category count_{f}^{j}.

Specifically, the count_{f}^{j} can be calculated by using the following formula:

$${count}_{f}^{j} = {\sum }_{i = 1}^{M} 1 ( if {x}_{{i}_{f}}^{j} \neq 0 ) \qquad ( 3 )$$

The embodiment is described by taking the calculation for at least one of the above-mentioned three statistics as an example. In a practical application, any combination of the three statistics may be used. Certainly, other statistics may be calculated or any combination of the above-mentioned three statistics and the other statistics may be used in other embodiments, and the embodiment is not specifically limited thereto.

203: performing statistics on the feature values for the samples in all the categories and/or performing statistics on the numbers of occurrence of the feature in the samples in all the categories by using the second MapReduce model, and calculating the contribution value of each feature to the category according to the result of the statistics.

The output key-value pair for the first MapReduce model is considered as the input key-value pair for the second MapReduce model, in which the key is the feature serial number and the value is the statistic.

In the embodiment, the contribution value shows a representativeness of a feature to a category. The larger the contribution value, the stronger the representativeness of the feature to the category. The less the contribution value, the weaker the representativeness of the feature to the category. Therefore, the contribution value may reflect whether the corresponding feature may represent a category, thereby the feature may be selected based on the contribution value.

There may be various formulas for calculating the contribution value rank_{f} in the second MapReduce model, including but not limited to:

$${rank}_{f} = \frac{{\sum }_{j = 1}^{W} ( ( \frac{{sum}_{f}^{j}}{{count}_{f}^{j}} - \frac{{sum}_{f}}{{count}_{f}} ) * {count}_{f}^{j} )}{{\sum }_{j = 1}^{W} ( {sum\_q}_{f}^{j} - \frac{{( {sum}_{f}^{i} )}^{2}}{{count}_{f}^{j}} )} ; \qquad ( 4 )$$

in which the sum_{f}=Σⱼ₌₁^{W}(sum_{f}^{j}), count_{f}=Σⱼ₌₁^{W}(count_{f}^{j}), for the sum_{f}^{j}, sum_q_{f}^{j}, count_{f}^{j}, the above-mentioned formulas (1) to (3) may be referred, which are not described here.

204: selecting a feature based on the contribution value.

Step 204 may include:

determining a specified number of the contribution values in a descending order of the contribution values, and selecting the features corresponding to the determined contribution values from all the features.

The specified number may be set as required, and is not limited to that described in this embodiment. For example, the specified number is T. The obtained contribution values may be sorted in a descending order, and the top T contribution values are selected. The features corresponding to the top T contribution values are selected as the final results.

In the embodiment, the second MapReduce model may process data by using the Map function and the Reduce function. Specifically, the input of the Map function is the feature serial number and corresponding statistic mentioned above. The contribution value of each feature to the category is obtained by performing calculation on the statistic with the Map function. The feature serial number is output as the key, and the contribution value is output as the value. All the contribution values output by the Map function are sorted by using the Reduce function. The final results may be obtained by selecting the required features from all the features according to the sorting result. The contribution value may be calculated by using the formula (4) mentioned above in the Map function of the second MapReduce model. Certainly, other formulas may be used, and the embodiment is not specifically limited thereto.

In the above-mentioned method according to the invention, the samples are sorted according to primary keys; a statistic of each feature in each category is acquired by taking the primary key and a corresponding feature value as an input key-value pair and calculating with a first MapReduce model, and the feature serial number and the statistic are output as an output key-value pair; a contribution value of each feature to the category is acquired by performing calculation on the output key-value pair with a second MapReduce model, and a feature is selected based on the contribution value. Therefore, the present invention can greatly improve data processing rate, reduce data processing time and consequently the computing costs. Moreover, the fast feature selection is achieved by performing two MapReduce model calculations.

### Third Embodiment

Referring to FIG. 4, the embodiment provides a device for processing data, including:

an sorting module 40, configured to sort samples according to primary keys, wherein the primary key includes a feature serial number and a sample serial number, and wherein a column value corresponding to the primary key is a feature value for the sample;

a first processing module 402, configured to acquire a statistic of each feature in each category by taking the primary key and the feature value as an input key-value pair and calculating with a first algorithm model, and output the feature serial number and the statistic as an output key-value pair; and

a second processing module 403, configured to acquire a contribution value of each feature to the category by performing calculation on the output key-value pair with a second algorithm model, and select a feature based on the contribution value.

In the embodiment, the primary key refers to a column or a combination of columns in a distributed database storing the sample. A value in the column or the combination of columns may uniquely identify a row in the table of the database. The primary key and the corresponding column value may constitute a key-value pair. In the embodiment, the primary key includes a feature serial number and a sample serial number, and the column value corresponding to the primary key is a feature value for the sample.

In the embodiment, specifically, the first algorithm model or the second algorithm model may be the MapReduce model. Certainly, other algorithm model may be used in other embodiment, and the embodiment is not specifically limited thereto.

According to the embodiment, the samples may be stored in the database in advance. The samples may be stored according to the categories, and each category includes one or more samples. A feature refers to an element relevant to the sample and may reflect the attributes/property of the sample to some extent. The feature can be set as needed. Each feature has a feature serial number for identifying the feature. Each feature also has a feature value. The specific value of the feature value may be obtained by performing statistics or calculating following a preset rule.

In the embodiment, the contribution value shows representativeness of a feature to a category. The larger the contribution value, the stronger the representativeness of the feature to the category. The less the contribution value, the weaker the representativeness of the feature to the category. Therefore, the contribution value may reflect whether the corresponding feature may represent a category so that the feature may be selected based on the contribution value.

In combination with the device mentioned above, in a first embodiment, the sorting module 401 includes:

a first sorting unit, configured to sort the samples according to the feature serial numbers, and then sort the samples with the same feature serial number according to the sample serial numbers, if the primary key is sequentially spliced by the feature serial number and the sample serial number; or

a second sorting unit, configured to sort the samples according to the sample serial numbers, and then sort the samples with the same sample serial number according to the feature serial numbers, if the primary key is sequentially spliced by the sample serial number and the feature serial number.

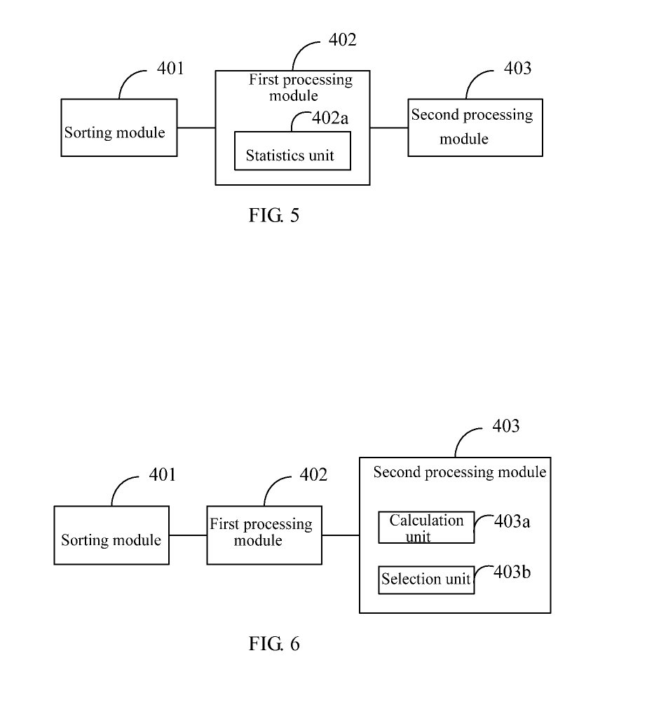

Referring to FIG. 5, in combination with the device mentioned above, in a second embodiment, the first processing module 402 includes:

a statistics unit 402a, configured to perform statistics on the feature values for the samples in each category and/or perform statistics on the number of occurrence of the feature in the samples in each category by using the first algorithm model.

In combination with the second embodiment mentioned above, in a third embodiment, the statistics unit 402a is configured to:

for each category, calculate a sum of the feature values for all the samples belonging to the category; and/or,

for each category, calculate a sum of square of the feature values for all the samples belonging to the category.

In combination with the second embodiment mentioned above, in a fourth embodiment, the statistics unit 402a is configured to:

for each category, record for each feature, the number of times that a feature value thereof being a non-zero value in all the samples in the category, as the number of occurrence of the feature in the samples in the category.

Referring to FIG. 6, in combination with the device mentioned above, in a fifth embodiment, the second processing module 403 includes:

a calculation unit 403a, configured to perform statistics on the feature values for the samples in all the categories and/or performing statistics on the numbers of occurrence of the features in the samples in all the categories by using the second algorithm model, and calculate the contribution value of each feature to the category according to the result of the statistics.

In combination with the device mentioned above, in a sixth embodiment, the second processing module 403 includes:

a selection unit 403b, configured to determine a specified number of the contribution values in a descending order of the contribution values, and select the features corresponding to the determined contribution values from all the features.

The device mentioned above according to the embodiment may implement any of the method according to any one of the above-mentioned method. For the detailed process, reference may be made to the description in the method embodiments, which is not described herein anymore.

In the above-mentioned device according to the invention, the samples are sorted according to primary keys; a statistic of each feature in each category is acquired by taking the primary key and a corresponding feature value as an input key-value pair and calculating with a first algorithm model, and the feature serial number and the statistic are output as an output key-value pair; a contribution value of each feature to the category is acquired by performing calculation on the output key-value pair with a second algorithm model, and a feature is selected based on the contribution value. Therefore, the present invention can greatly improve data processing rate, reduce data processing time and consequently computing costs. Moreover, the fast feature selection is achieved by performing two algorithm model calculations.

It can be understood by those skilled in the art that all or part of the steps for implementing the embodiments mentioned above can be implemented by using hardware or by program instructing the related hardware. The program may be stored in a computer readable storage medium, including but not limited to, ROM, disc, CD.

Preferred embodiments of the present invention are disclosed above, which should not be interpreted as limiting the present invention. Therefore, any modifications, equivalents and improvements made within the spirit and principle of the present invention should fall within the scope of protection of the present invention.

1. A method for processing data, comprising:
sorting samples from the data according to a primary key, wherein the primary key comprises a feature serial number and a sample serial number;
acquiring a statistic of each feature in each category by taking the primary key and the feature value as an input key-value pair, and performing a calculation with a first algorithm model, to obtain the feature serial number and the statistic as an output key-value pair; and
acquiring a contribution value of each feature to the category by performing a calculation on the output key-value pair with a second algorithm model, and selecting a feature based on the contribution value.

2. The method according to claim 1, wherein a column value corresponding to the primary key is used as a feature value of each sample.

3. The method according to claim 1, wherein the sorting samples according to the primary key comprises:
sorting the samples according to the feature serial numbers, and then sorting the samples with the same feature serial number according to the sample serial numbers, if the primary key is sequentially spliced by the feature serial number and the sample serial number; or
sorting the samples according to the sample serial numbers, and then sorting the samples with the same sample serial number according to the feature serial numbers, if the primary key is sequentially spliced by the sample serial number and the feature serial number.

4. The method according to claim 1, wherein the acquiring a statistic of each feature in each category by calculating with a first algorithm model comprises:
at least one of performing statistics on the feature values for the samples in each category and performing statistics on the number of occurrence of the feature in the samples in each category by using the first algorithm model.

5. The method according to claim 4, wherein the performing statistics on the feature values for the samples in each category comprises at least one of the following steps:
for each category, calculating a sum of the feature values for all the samples belonging to the category; and
for each category, calculating a sum of the feature values squared for all the samples belonging to the category.

6. The method according to claim 4, wherein the performing statistics on the number of occurrence of the feature in the samples in each category comprises:
for each category, recording for each feature, the number of times that a feature value thereof being a non-zero value in all the samples in the category, as the number of occurrence of the feature in the samples in the category.

7. The method according to claim 1, wherein the acquiring a contribution value of each feature to the category by performing calculation on the output key-value pair with a second algorithm model comprises:
performing at least one of statistics on the feature values for the samples in all the categories and statistics on the numbers of occurrence of the features in the samples in all the categories by using the second algorithm model, and
calculating the contribution value of each feature to the category according to the result of the statistics.

8. The method according to claim 1, wherein the selecting a feature based on the contribution value comprises:
determining a specified number of the contribution values in a descending order of the contribution values, and selecting the features corresponding to the determined contribution values from all the features.

9. A device for processing data, comprising:
a sorting module, configured to sort samples from the data according to a primary key, wherein the primary key comprises a feature serial number and a sample serial number;
a first processing module, configured to acquire a statistic of each feature in each category by taking the primary key and the feature value as an input key-value pair calculating with a first algorithm model, and output the feature serial number and the statistic as an output key-value pair; and
a second processing module, configured to acquire a contribution value of each feature to the category by performing calculation on the output key-value pair with a second algorithm model, and select a feature based on the contribution value.

10. The device according to claim 9, wherein a column value corresponding to the primary key is used as a feature value of each sample.

11. The device according to claim 10, wherein the sorting module comprises:
a first sorting unit, configured to sort the samples according to the feature serial numbers, and then sort the samples with the same feature serial number according to the sample serial numbers, in the case where the primary key is sequentially spliced by the feature serial number and the sample serial number; or
a second sorting unit, configured to sort the samples according to the sample serial numbers, and then sort the samples with the same sample serial number according to the feature serial numbers, in the case where the primary key is sequentially spliced by the sample serial number and the feature serial number.

12. The device according to claim 10, wherein the first processing module comprises:
a statistics unit, configured for performing at least one of statistics on the feature values for the samples in each category and statistics on the number of occurrence of the feature in the samples in each category by using the first algorithm model.

13. The device according to claim 12, wherein the statistics unit is configured for, for each category, at least one of the following:
calculating a sum of the feature values for all the samples belonging to the category; and
calculating a sum of square of the feature values for all the samples belonging to the category.

14. The device according to claim 12, wherein the statistics unit is configured for:
for each category, recording for each feature, the number of times that a feature value thereof being a non-zero value in all the samples in the category, as the number of occurrence of the feature in the samples in the category.

15. The device according to claim 10, wherein the second processing module comprises:
a calculation unit, configured for performing at least one of statistics on the feature values for the samples in all the categories and statistics on the numbers of occurrence of the features in the samples in all the categories by using the second algorithm model, and calculating the contribution value of each feature to the category according to the result of the statistics.

16. The device according to claim 10, wherein the second processing module comprises:
a selection unit, configured for determining a specified number of the contribution values in a descending order of the contribution values, and selecting the features corresponding to the determined contribution values from all the features.
